(19) United States
(12) Patent Application Publication
(10) Pub. No.: US 2026/0106189 A1
(43) Pub. Date: Apr. 16, 2026

(54) TANK, AND REDOX FLOW BATTERY SYSTEM

(71) Applicant: Sumitomo Electric Industries, Ltd., Osaka-shi, Osaka (JP)

(72) Inventor: Masahiro KUWABARA, Osaka-shi, Osaka (JP)

(73) Assignee: Sumitomo Electric Industries, Ltd., Osaka-shi, Osaka (JP)

(21) Appl. No.: 19/115,814

(22) PCT Filed: Aug. 17, 2023
(86) PCT No.: PCT/JP2023/029713

§ 371 Date: Mar. 27, 2025

(30) Foreign Application Priority Data
Sep. 30, 2022 (JP) 2022-158716

(51) Int. Cl. H01M 8/04082; H01M 8/0289; H01M 8/18

(52) U.S. Cl. CPC H01M 8/04216; H01M 8/0289; H01M 8/188

(57) ABSTRACT

A tank includes a tank body and an inner layer disposed at an inner surface of the tank body, wherein peel strength of the inner layer with respect to the tank body is smaller than breaking strength of the inner layer.

### TECHNICAL FIELD

The present disclosure relates to a tank and a redox flow battery system. This application claims priority based on Japanese Patent Application No. 2022-158716 filed on Sep. 30, 2022. The entire contents of the Japanese patent application are incorporated herein by reference.

### BACKGROUND ART

Patent literature 1 and 2 disclose a tank for a redox flow battery in which an electrolyte is stored. Patent literature 1 describes lining of an inner surface of the tank made of metal with a resin film. Patent literature 2 describes that the tank is housed in a container. The tank of Patent Literature 2 is constituted of resin, rubber, or the like. The container is made of metal. The container is, for example, an international shipping container of the International Organization for Standardization (ISO) standard. It is described that a coating layer made of resin or the like is provided on the inner surface of the container. In the following description, the “metal tank” of Patent Literature 1 and the “container” of Patent Literature 2 may be referred to as a “tank body”. The “resin film” of Patent literature 1 and the “coating layer” of Patent literature 2 may be referred to as “inner layer”.

### CITATION LIST

### Patent Literature

Patent literature 1: Japanese Unexamined Patent Application Publication No. H10-208766
Patent literature 2: WO 2019/102544

### SUMMARY OF THE INVENTION

A tank of the present disclosure includes a tank body, and an inner layer disposed at an inner surface of the tank body. Peeling strength of the inner layer with respect to the tank body is smaller than breaking strength of the inner layer.

### BRIEF DESCRIPTION OF THE DRAWINGS

FIG. 1 is a schematic diagram showing a configuration of a redox flow battery system according to an embodiment.

FIG. 2 is a cross-sectional view showing the structure of the tank according to the embodiment.

FIG. 3 is a cross-sectional view showing the structure of the tank according to the embodiment in an enlarged scale.

FIG. 4 is a diagram for explaining a testing method of the peeling strength of the inner layer of the tank according to the embodiment.

FIG. 5 is another diagram for explaining a testing method of the peeling strength of the inner layer in the tank according to the embodiment.

FIG. 6 is a cross-sectional view showing another example of the structure of the tank according to the embodiment.

FIG. 7 is a diagram for explaining a measuring method of peeling strength in a test example.

### DETAILED DESCRIPTION

### Problems to be Solved by the Present Disclosure

When the tank receives an unexpected impact force due to an earthquake or the like, a crack may occur in the tank body. When the crack occurred in the tank body propagates to the inner layer, the electrolyte in the tank may leak from the crack.

An object of the present disclosure is to provide a tank capable of suppressing leakage of a substance such as an electrolyte in the tank to the outside of the tank.

### ADVANTAGEOUS EFFECT OF THE PRESENT DISCLOSURE

The tank of the present disclosure can suppress leakage of a substance such as an electrolyte in the tank to the outside of the tank.

### DESCRIPTION OF EMBODIMENTS

First, embodiments of the present disclosure will be listed and described.

(1) A tank according to an embodiment of the present disclosure includes a tank body, and an inner layer disposed at an inner surface of the tank body. Peeling strength of the inner layer with respect to the tank body is smaller than breaking strength of the inner layer.

According to the tank of the present disclosure, the peeling strength of the inner layer is smaller than the breaking strength of the inner layer, and thus, even when a crack occurs in the tank body, the occurrence of the crack in the inner layer can be suppressed. The reason is that the inner layer peels off from the tank body before the inner layer is broken by the crack occurred in the tank body. Thus, the tank of the present disclosure can suppress leakage of a substance such as an electrolyte in the tank to the outside of the tank. The peeling strength is an index indicating the adhesive force between the tank body and the inner layer.

(2) In the tank of (1), the peeling strength may be 500 MPa or less.

According to the configuration of (2), the inner layer is easily peeled off from the tank body before the inner layer is broken.

(3) In the tank according to (1) or (2), a material of the inner layer may be resin or rubber.

According to the configuration of (3), it is possible to suppress corrosion of the tank body due to the electrolyte.

(4) In the tank according to any one of (1) to (3), a thickness of the inner layer may be 0.5 mm to 20 mm.

According to the configuration of (4), the function of the inner layer can be sufficiently exhibited.

(5) In the tank according to any one of (1) to (4), a material of the tank body may be concrete or metal.

According to the configuration of (5), the tank body is less likely to deteriorate over a long period of time.

(6) In the tank according to any one of (1) to (5), a flatness of the inner surface of the tank body may be 5 mm or less.

According to the configuration of (6), the peeling strength can be reduced, and thus the inner layer is easily peeled off from the tank body before the inner layer is broken.

(7) In the tank according to any one of (1) to (6), the tank body may include a base and a primer layer provided at a surface of the base on an inner side. The primer layer may constitute the inner surface of the tank body.

According to the configuration of (7), the peeling strength can be reduced, and thus the inner layer is easily peeled off from the tank body before the inner layer is broken.

(8) In the tank according to (7), a physical property value of a material of the primer layer and a physical property value of a material of the inner layer may differ from each other.

According to the configuration of (8), since the physical property value of the material of the primer layer differs from the physical property value of the material of the inner layer, an interface between the primer layer and the inner layer exists between the primer layer and the inner layer. Even when a crack occurs in the tank body, the crack is less likely to propagate to the inner layer due to the presence of such an interface, as compared with the case where the physical property values are the same.

(9) In the tank according to (7) or (8), breaking elongation of a material of the primer layer and breaking elongation of a material of the inner layer may differ from each other.

According to the above configuration (9), by constituting the primer layer and the inner layer formed of different breaking elongations materials, the respective elongation states of the layers are different, and thus the crack is less likely to propagate to the inner layer even when the crack occurs in the tank body.

(10) A redox flow battery system according to an embodiment of the present disclosure includes a positive electrolyte tank in which a positive electrolyte is stored and a negative electrolyte tank in which a negative electrolyte is stored. At least one of the positive electrolyte tank and the negative electrolyte tank is the tank according to any one of (1) to (9).

The redox flow battery system of the present disclosure includes the tank of the present disclosure, and thus it is possible to suppress the leakage of the electrolyte in the tank.

### DETAILED DESCRIPTION OF EMBODIMENTS

Hereinafter, specific examples of a tank and a redox flow battery system according to embodiments of the present disclosure will be described with reference to the drawings. In the drawings, the same reference numerals denote the same or corresponding parts. Hereinafter, the redox flow battery system may be referred to as an “RF battery system”.

It is noted that, the present invention is not limited to these examples, but is defined by the scope of the claims, and is intended to include all modifications within the scope and meaning equivalent to the scope of the claims.

### <RF Battery System>

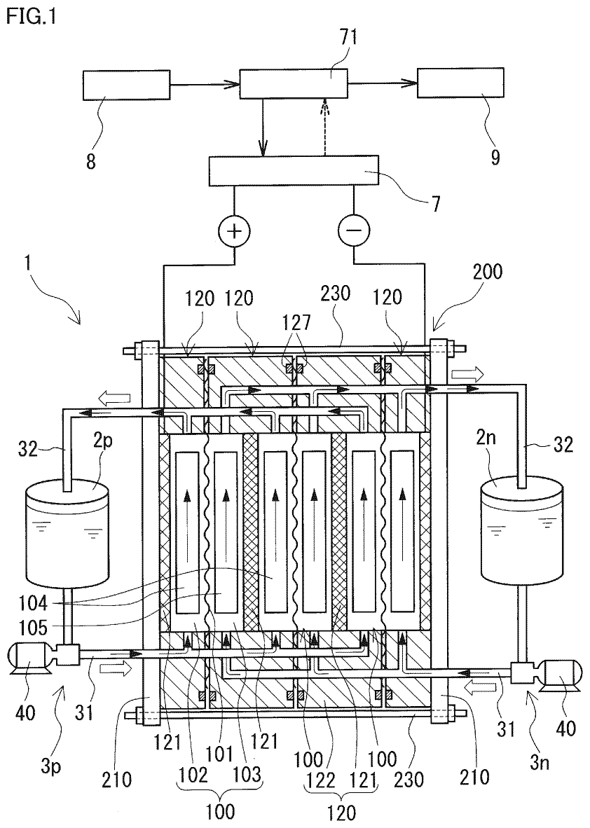

An RF battery system 1 according to an embodiment will be described with reference to FIG. 1. RF battery system 1 is an electrolyte circulation type secondary battery. RF battery system 1 performs charging and discharging by using a difference between an oxidation-reduction potential of a positive electrode active material included in a positive electrolyte and an oxidation-reduction potential of a negative electrode active material included in a negative electrolyte.

As the electrolyte, a known electrolyte can be used. The positive electrolyte includes the positive electrode active material. The positive electrode active material is, for example, one or more selected from the group consisting of manganese ions, vanadium ions, iron ions, polyacids, quinone derivatives, and amines. The negative electrolyte includes the negative electrode active material. The negative electrode active material is, for example, one or more selected from the group consisting of titanium ions, vanadium ions, chromium ions, polyacids, quinone derivatives, and amines. In a specific example of the electrolyte, both the positive electrolyte and the negative electrolyte contain vanadium ions. In another example of the electrolyte, the positive electrolyte contains manganese ions, and the negative electrolyte contains titanium ions. The solvent of the positive electrolyte and the negative electrolyte is, for example, an aqueous solution containing one or more acids or acid salts selected from the group consisting of sulfuric acid, phosphoric acid, nitric acid, and hydrochloric acid.

RF battery system 1 is typically connected to a power generation unit 8 and a load 9 via an alternating current/direct current converter 7 and a transformer facility 71. RF battery system 1 can charge the electric power generated by power generation unit 8 and discharge the charged electric power to load 9. Power generation unit 8 is a power generation facility using natural energy such as solar power generation or wind power generation, or other general power plants. RF battery system 1 is used for load leveling, instantaneous voltage drop compensation, emergency power supply, and output smoothing of natural energy power generation, for example.

RF battery system 1 includes a battery cell 100, a positive electrolyte tank 2p, and a negative electrolyte tank 2n. RF battery system 1 further includes a pipe 3p that connects battery cell 100 and positive electrolyte tank 2p, a pipe 3n that connects battery cell 100 and negative electrolyte tank 2n, and a pump 40 provided at each of pipes 3p and 3n. Positive electrolyte tank 2p stores a positive electrolyte. Negative electrolyte tank 2n stores a negative electrolyte. The positive electrolyte circulates between positive electrolyte tank 2p and battery cell 100 through pipe 3p. The negative electrolyte circulates between negative electrolyte tank 2n and battery cell 100 through pipe 3n.

### (Battery Cell)

Battery cell 100 includes a positive electrode 104, a negative electrode 105, and a membrane 101. Membrane 101 is disposed between positive electrode 104 and negative electrode 105. Battery cell 100 is divided into a positive electrode cell 102 and a negative electrode cell 103 by membrane 101. Positive electrode 104 is disposed in positive electrode cell 102. Negative electrode 105 is disposed in negative electrode cell 103. A positive electrolyte is supplied to positive electrode cell 102. A negative electrolyte is supplied to negative electrode cell 103. A known configuration can be appropriately used as the configuration of battery cell 100.

Pipe 3p and pipe 3n have the same configuration. Each of pipes 3p and 3n includes a first pipe 31 and a second pipe 32. Pump 40 is provided at first pipe 31. Pump 40 circulates the electrolyte in tanks 2p and 2n to battery cell 100. First pipe 31 in pipe 3p is a pipe that sends the positive electrolyte from positive electrolyte tank 2p to battery cell 100. Second pipe 32 in pipe 3p is a pipe for returning the positive electrolyte from battery cell 100 to positive electrolyte tank 2p. That is, the positive electrolyte is supplied from positive electrolyte tank 2p to positive electrode cell 102 through first pipe 31. The positive electrolyte discharged from positive electrode cell 102 is returned to positive electrolyte tank 2p through second pipe 32. First pipe 31 in pipe 3n is a pipe for sending the negative electrolyte from negative electrolyte tank 2n to battery cell 100. Second pipe 32 in pipe 3n is a pipe for returning the negative electrolyte from battery cell 100 to negative electrolyte tank 2n. That is, the negative electrolyte is supplied from negative electrolyte tank 2n to negative electrode cell 103 through first pipe 31. The negative electrolyte discharged from negative electrode cell 103 is returned to negative electrolyte tank 2n through second pipe 32. During charging or discharging, the electrolyte is circulated by pump 40. When charging and discharging are not performed, pump 40 is stopped and the electrolyte is not circulated.

RF battery system 1 may have a configuration with a single battery cell 100, or a configuration with a plurality of battery cells 100. In the embodiment, as shown in FIG. 1, it includes a cell stack 200 in which a plurality of battery cells 100 are stacked. Cell stack 200 is configured by repeatedly stacking a cell frame 120, positive electrode 104, membrane 101, and negative electrode 105 in this order. End plates 210 are disposed at both ends of cell stack 200. Cell stack 200 is integrated by fastening end plates 210 with fastening members 230. A known configuration can be appropriately used as the configuration of cell stack 200.

Cell frame 120 includes a bipolar plate 121 and a frame body 122. Bipolar plate 121 is disposed between positive electrode 104 and negative electrode 105. Frame body 122 is provided around bipolar plate 121. A recessed portion is formed on the inner side of frame body 122 by bipolar plate 121 and frame body 122. The recessed portions are respectively provided on both surfaces of bipolar plate 121. In each recessed portion, positive electrode 104 and negative electrode 105 are respectively housed interposing bipolar plate 121.

As shown in FIG. 1, one battery cell 100 is formed by arranging positive electrode 104 and negative electrode 105 with membrane 101 interposed between bipolar plates 121 of adjacent cell frames 120. For example, a ring-shaped seal member 127 is disposed between frame bodies 122 of cell frames 120. The number of battery cells 100 stacked in cell stack 200 can be appropriately selected.

Although not shown in detail, frame body 122 includes a liquid supply manifold for supplying each electrolyte and a liquid discharge manifold for discharging each electrolyte. Each manifold is provided to penetrate frame body 122, and by stacking cell frames 120, it configures the flow channel for each electrolyte. These flow channels are connected to first pipe 31 and second pipe 32, respectively.

### <Tank>

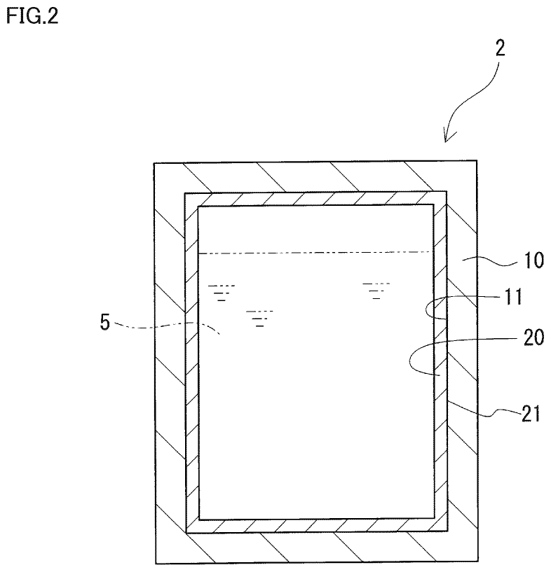

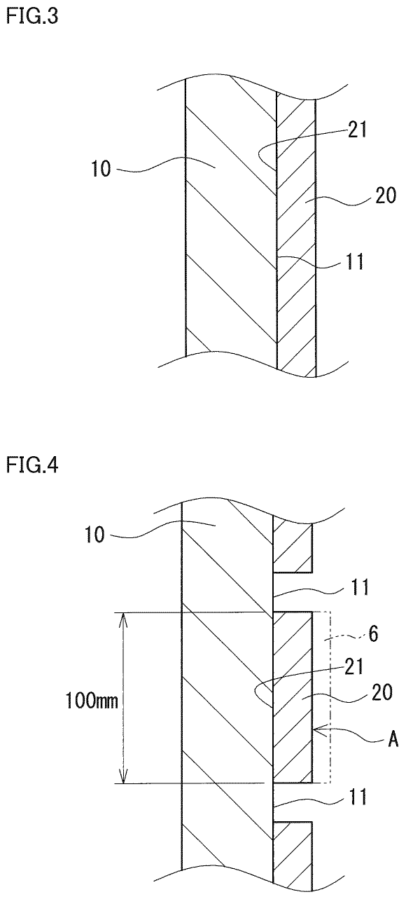

A tank 2 according to the embodiment will be described with reference to FIG. 2 and FIG. 3. Tank 2 according to the embodiment is positive electrolyte tank 2p and negative electrolyte tank 2n provided in RF battery system 1 shown in FIG. 1. As shown in FIG. 2, tank 2 includes a tank body 10 and an inner layer 20. FIG. 2 is a cross-sectional view of tank 2 cut in the longitudinal direction. The longitudinal direction is a direction from the top surface portion of tank 2 toward the bottom portion of tank 2. In FIG. 2, pipes 3p, 3n, and the like shown in FIG. 1 are omitted. FIG. 3 is a view shown in an enlarged scale of a part of the cross section of tank 2 shown in FIG. 2. Tank 2 stores an electrolyte 5, which is either a positive electrolyte or a negative electrolyte. One of the features of tank 2 is that the peeling strength of inner layer 20 with respect to tank body 10 is smaller than the breaking strength of inner layer 20. Since the peeling strength of inner layer 20 is smaller than the breaking strength of inner layer 20, even when a crack occurs in tank body 10, the occurrence of a crack in inner layer 20 can be suppressed. Since cracks are less likely to occur in inner layer 20, inner layer 20 is less likely to break. Thus, it is possible to suppress the leakage of electrolyte 5 in tank 2.

In RF battery system 1, the battery capacity increases as the amount of electrolyte 5 stored in tank 2 increases. That is, as the volume of tank 2 is larger, the battery capacity of RF battery system 1 can be increased. The volume of tank 2 can be appropriately selected according to the battery capacity of RF battery system 1. The volume of tank 2 is, for example, 10 m³ or more.

### (Tank Body)

Tank body 10 is the body that constitutes tank 2. Tank body 10 has a role of supporting a force applied to tank 2. Tank body 10 has strength to maintain the shape of tank 2 even in a state where electrolyte 5 is stored. Tank body 10 shown in FIG. 2 includes a bottom portion, a top surface portion, and a wall portion. The wall portion connects the bottom portion and the top surface portion.

### <Material>

Tank body 10 is constituted of a material having durability that is less likely to deteriorate over a long period of time. The material of tank body 10 is, for example, concrete or metal. Concrete mentioned here includes reinforced concrete as well. The metal is, for example, iron, an iron alloy, aluminum, or an aluminum alloy. Iron alloys include steels such as carbon steel or stainless steel.

Tank body 10 made of concrete facilitates construction of tank 2 having a large volume. Further, tank body 10 made of concrete can achieve cost reduction as compared with tank body 10 made of metal. The cost of tank body 10 is basically determined by the amount of material used. The larger the volume of tank 2, the more advantageous it is for cost reduction to construct tank body 10 of the tank with concrete. For example, an existing container can be used as tank body 10 made of metal. A specific example of an existing container is an international shipping container that conforms to ISO standards. Generally, these containers are constituted of carbon steel, such as rolled steel for general construction.

### (Inner Layer)

Inner layer 20 is disposed at an inner surface 11 of tank body 10. Inner layer 20 is bonded to tank body 10. Inner layer 20 has an adhesion portion 21 on a surface facing inner surface 11. Inner layer 20 is bonded to inner surface 11 of tank body 10 by adhesion portion 21. Inner layer 20 has a surface facing the internal space of tank 2. Inner layer 20 has a role of suppressing corrosion of tank body 10 by electrolyte 5. Inner layer 20 may be provided at least in a portion in contact with electrolyte 5. Inner layer 20 may be provided so as to cover entire inner surface 11 of tank body 10 as shown in FIG. 2. That is, inner layer 20 may be provided so as to cover all of the inner surface of the bottom portion, the inner surface of the wall portion, and the inner surface of the top surface portion of tank body 10. In the embodiment, as shown in FIG. 3, inner layer 20 is in direct contact with inner surface 11 of tank body 10.

### <Material>

Inner layer 20 is constituted of a material having electrical insulation and resistance to electrolyte 5. The material of inner layer 20 is, for example, resin or rubber. The resin mentioned here also includes a fiber-reinforced resin (FRP) in which resin and fiber are combined. The resin constituting inner layer 20 is, for example, polyethylene (PE), polyvinyl chloride (PVC), unsaturated polyester, phenol, vinyl ester, polypropylene, nylon, or acrylonitrile-butadiene-styrene copolymer resin (ABS). The rubber constituting inner layer 20 is, for example, ethylene propylene diene rubber (EPDM) or fluorine rubber (FKM). The fiber contained in the FRP is, for example, at least one of glass fiber and carbon fiber.

### <Thickness>

The thickness of inner layer 20 is, for example, 0.5 mm to 20 mm. The larger the thickness of inner layer 20 is, the less likely defects such as pinholes are to occur in inner layer 20. The larger the thickness of inner layer 20 is, the higher the strength of inner layer 20 is. When the thickness of inner layer 20 is 0.5 mm or more, corrosion of tank body 10 is easily suppressed. When the thickness of inner layer 20 is 20 mm or less, the material and cost of inner layer 20 can be reduced. The thickness of inner layer 20 may be 1 mm to 15 mm, or 2 mm to 10 mm.

### <Forming Method>

Inner layer 20 can be formed by, for example, a coating method. As the coating method, for example, an application method or a spraying method can be used. Specifically, inner layer 20 is formed by coating or spraying materials such as resin constituting inner layer 20 in a molten state to inner surface 11 of tank body 10, and then solidifying the materials. The coating or spraying is repeated until inner layer 20 has a predetermined thickness. When inner layer 20 is formed by the coating method, inner layer 20 is bonded to inner surface 11 of tank body 10 by the adhesive force of the resin or the like contained in inner layer 20. In this case, inner layer 20 itself has adhesive force, and adhesion portion 21 is formed on a surface of inner layer 20 facing inner surface 11. That is, adhesion portion 21 may be constituted of a material constituting inner layer 20 itself. A portion of inner layer 20 in contact with inner surface 11 constitutes adhesion portion 21. Inner layer 20 made of FRP may be formed by coating a mixed material in which short fibers are mixed with resin, or may be formed by repeating the coating of resin and attachment of a fiber sheet. In the embodiment, inner layer 20 is formed by a coating method.

In addition, inner layer 20 may be formed by adhering a sheet obtained by processing materials such as resin constituting inner layer 20 to inner surface 11 of tank body 10 with an adhesive. In this case, an adhesive layer (not shown) is formed on a surface of inner layer 20 facing inner surface 11, and thus inner layer 20 is bonded to inner surface 11 of tank body 10 by the adhesive layer. The adhesive layer is disposed between tank body 10 and inner layer 20. That is, the adhesive layer is disposed on inner surface 11 of tank body 10, and inner layer 20 is disposed on the adhesive layer. The material of the adhesive layer differs from the material of inner layer 20. When inner layer 20 is bonded to tank body 10 by the adhesive layer, inner layer 20 itself may not have adhesive force. In the configuration in which inner layer 20 has the adhesive layer, inner layer 20 includes the base layer and the adhesive layer, and the adhesive layer constitutes adhesion portion 21. The adhesive layer is constituted of an adhesive. The adhesive is, for example, a two component reaction type epoxy-based adhesive or a silicone-based elastic adhesive.

(Peeling Strength of Inner Layer with Respect to Tank Body)

The peeling strength of inner layer 20 with respect to tank body 10 is smaller than the breaking strength of inner layer 20. The peeling strength is a strength at which inner layer 20 peels off from tank body 10 when inner layer 20 is pulled in a direction along inner surface 11 of tank body 10. The breaking strength is a strength at which inner layer 20 breaks when inner layer 20 is pulled in a direction along inner surface 11 of tank body 10. The direction along inner surface 11 of tank body 10 is a direction parallel to inner surface 11.

Since the peeling strength of inner layer 20 is smaller than the breaking strength of inner layer 20, even when a crack occurs in tank body 10, the occurrence of a crack in inner layer 20 can be suppressed. The reason is as follows. When a crack occurs in tank body 10, inner layer 20 is pulled in a direction in which the crack opens. That is, due to the crack occurred in tank body 10, a tensile load in a direction along inner surface 11 of tank body 10 acts on inner layer 20. When the peeling strength of inner layer 20 is smaller than the breaking strength of inner layer 20, inner layer 20 peels off from tank body 10 before inner layer 20 is broken by the tensile load. As a result, the crack occurs in tank body 10 is less likely to propagate to inner layer 20. That is, even when a crack occurs in tank body 10, a crack is unlikely to occur in inner layer 20. When the peeling strength of inner layer 20 is equal to or more than the breaking strength of inner layer 20, inner layer 20 is not peeled off from tank body 10 due to the tensile load, and thus, cracks occur in inner layer 20.

The peeling strength is, for example, more than 0 and 500 MPa or less. When the peeling strength is 500 MPa or less, inner layer 20 is easily peeled off from tank body 10. The peeling strength may be 300 MPa or less, or 100 MPa or less. The peeling strength is a value larger than zero, and may be a strength capable of supporting inner layer 20 with respect to tank body 10. The lower limit of the peeling strength is, for example, 1 MPa. When the peeling strength is 1 MPa or more, inner layer 20 is easily maintained in a state of being supported by tank body 10. The peeling strength may be, for example, 1 MPa to 500 MPa, 2 MPa to 300 MPa, 3 MPa to 150 MPa, or 3 MPa to 100 MPa. The peeling strength was measured in accordance with the measurement of peeling strength described in Test Example 1 below.

The upper limit of the peeling strength may be in a range smaller than the breaking strength, and may vary depending on the material of inner layer 20. When the material of inner layer 20 is PE, the peeling strength may be, for example, less than 35 MPa, or even 30 MPa or less. When the material of inner layer 20 is PVC, the peeling strength may be, for example, less than 60 MPa, or even 50 MPa or less. When the material of inner layer 20 is FRP, the peeling strength may be, for example, less than 500 MPa, or even 300 MPa or less. When the material of inner layer 20 is EPDM, the peeling strength may be, for example, less than 20 MPa, or even 15 MPa or less. When the material of inner layer 20 is FKM, the peeling strength may be, for example, less than 20 MPa, or even 15 MPa or less.

### (Breaking Strength of Inner Layer)

The breaking strength of inner layer 20 varies depending on the material of inner layer 20. The breaking strength of inner layer 20 made of PE is, for example, in the range of 20 MPa to 35 MPa. The breaking strength of inner layer 20 made of PVC is, for example, in the range of 40 MPa to 60 MPa. The breaking strength of inner layer 20 made of FRP is, for example, in the range of 300 MPa to 500 MPa. The breaking strength of inner layer 20 made of EPDM is, for example, in the range of 5 MPa to 20 MPa. The breaking strength of inner layer 20 made of FKM is, for example, in the range of 7 MPa to 20 MPa. The breaking strength was measured in accordance with the breaking strength measurement described in Test Example 1 below.

### (Flatness of Inner Surface of Tank Body)

The smaller the peeling strength, the easier it is for inner layer 20 to peel off from tank body 10. For example, when inner surface 11 of tank body 10 is smooth, the peeling strength is reduced. The smaller the flatness of inner surface 11 of tank body 10, the easier it is for inner layer 20 to peel off from tank body 10. The flatness of inner surface 11 can be reduced by, for example, smoothing inner surface 11 by polishing or the like. From the viewpoint of reducing the peeling strength, the flatness of inner surface 11 is, for example, 5 mm or less. The flatness of inner surface 11 may further be 4 mm or less, or 2 mm or less. The flatness mentioned here is a flatness within a 100 mm square region. The 100 mm square means a square with each side having 100 mm. The flatness is measured in accordance with JIS B 0621:1984 “Definitions and Designations of Geometrical Deviations”.

In addition, when the adhesive strength of inner layer 20 itself is small, the peeling strength is reduced. Further, as described above, when inner layer 20 is bonded to inner surface 11 of tank body 10 by the adhesive layer, the peeling strength is reduced due to the low adhesion strength of the adhesive layer. In a case where the adhesive strength of the adhesive layer is smaller than the breaking strength of inner layer 20, when the tensile load acts, interfacial breakage occurs at the interface between inner layer 20 and the adhesive layer or the interface between tank body 10 and the adhesive layer, and thus inner layer 20 is easily peeled off from tank body 10. The breaking strength of the adhesive layer may be smaller than the breaking strength of inner layer 20. In this case, when the tensile load acts, the adhesive layer itself undergoes cohesive failure, and thus inner layer 20 is easily peeled off from tank body 10.

### <Peeling Strength Testing Method>

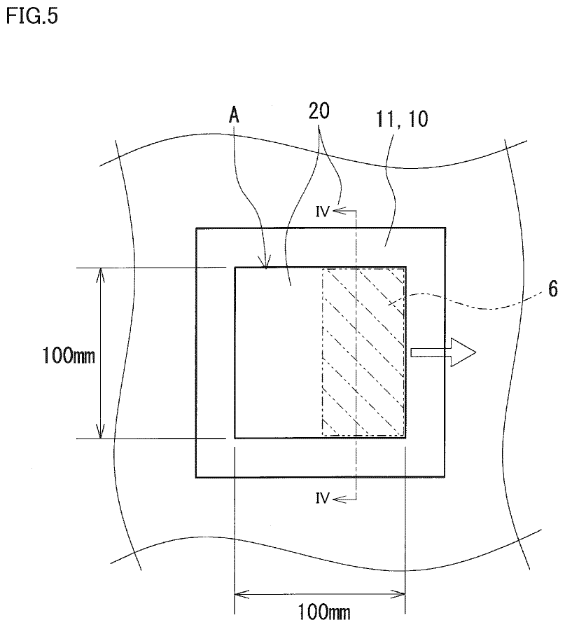

Whether the peeling strength of inner layer 20 is smaller than the breaking strength of inner layer 20 can be evaluated by the following peeling strength testing method. A testing method of the peeling strength of inner layer 20 will be described with reference to FIG. 4 and FIG. 5. FIG. 4 is a view shown in an enlarged scale of a part of the cross section of tank 2 shown in FIG. 2, similarly to FIG. 3. FIG. 5 is a view of tank 2 shown in FIG. 2 as viewed from the inner side. That is, FIG. 5 is a front view of the surface of inner layer 20. The cross section of the portion IV-IV in FIG. 5 corresponds to FIG. 4. The peeling strength test is conducted as follows. As shown in FIG. 5, a 100 mm square region A is selected from the surface of inner layer 20. Inner layer 20 around region A is removed to separate inner layer 20 inside region A from inner layer 20 outside region A. As shown in FIG. 4 and FIG. 5, inner surface 11 of tank body 10 is exposed in the portion where inner layer 20 is removed. Region Ais divided into halves, and a jig 6 is fixed to the half of region A. In FIG. 5, region A is divided into right and left halves, and jig 6 is fixed to the right half. In FIG. 5, the right half of region A to which jig 6 is fixed is shown by hatching. Jig 6 is fixed to a half of region A by, for example, an adhesive. This adhesive is an adhesive such that the adhesive strength between jig 6 and region A is sufficiently higher than the peeling strength between tank body 10 and inner layer 20. Jig 6 is moved at a constant speed in a direction parallel to inner surface 11 to pull inner layer 20 in region A. As shown in FIG. 5, when jig 6 is fixed to the right half of region A, jig 6 is moved in the right direction. Jig 6 may be fixed to the left half of region A. In this case, jig 6 is moved to the left direction. Region A may be divided into upper and lower halves, and jig 6 may be fixed to the upper half or the lower half. When jig 6 is fixed to the upper half of region A, jig 6 is moved upward. When jig 6 is fixed to the lower half of region A, jig 6 is moved downward.

When inner layer 20 in region A is pulled by jig 6, if inner layer 20 in region A is peeled off from tank body 10 without being broken, the peeling strength of inner layer 20 is regarded as being smaller than the breaking strength of inner layer 20. Further, a value obtained by dividing the maximum tensile load until inner layer 20 of region A peels off by the area of region A is regarded as the peeling strength of inner layer 20. When jig 6 is pulled, if inner layer 20 in region A is broken without being peeled off from tank body 10, the peeling strength of inner layer 20 is regarded as being equal to or higher than the breaking strength of inner layer 20. In this case, a part of inner layer 20 of region A remains on inner surface 11 of tank body 10.

### (Primer Layer)

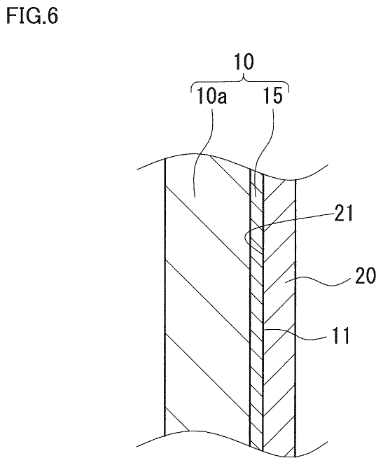

As shown in FIG. 6, tank body 10 may have a primer layer 15. In the configuration in which tank body 10 includes primer layer 15, tank body 10 includes a base 10a and primer layer 15, and primer layer 15 constitutes inner surface 11 of tank body 10. The material of base 10a is different from the material of primer layer 15. Base 10a is constituted of the material of tank body 10 described above. Primer layer 15 is constituted of resin as described later. Primer layer 15 is provided at the surface of the inner side of base 10a. Primer layer 15 has a surface facing inner layer 20. When tank body 10 includes primer layer 15, inner layer 20 is disposed at the surface of primer layer 15. That is, primer layer 15 is positioned in a lower layer than inner layer 20, and primer layer 15 is disposed between tank body 10 and inner layer 20. The main role of primer layer 15 is to promote peeling of inner layer 20 from tank body 10, that is, to reduce the peeling strength.

### <Material>

The material of primer layer 15 is, for example, resin. The resin constituting primer layer 15 is, for example, epoxy (EP), acrylic (PMMA), polyester (PET), polyacetal (POM), fluorine resin (PTFE), or polyurethane (PUR). Since EP, PMMA, or PET has excellent smoothness, primer layer 15 having high smoothness can be formed. Since POM or PTFE has excellent lubricity, primer layer 15 having high lubricity can be formed. By having primer layer 15 with high smoothness or lubricity, interfacial breakage is likely to occur at the interface between inner layer 20 and primer layer 15 when the tensile load acts. As a result, the peeling strength is reduced, and inner layer 20 is easily peeled off from tank body 10. Primer layer 15 made of PUR has low strength. When the tensile load acts, primer layer 15 undergoes cohesive failure, and thus inner layer 20 is easily peeled off from tank body 10.

The material of primer layer 15 may have a physical property value different from that of the material of inner layer 20. The physical property value is, for example, breaking elongation or tensile strength. When the breaking elongation of the material is different between primer layer 15 and inner layer 20, for example, when the relationship where the breaking elongation of the material of primer layer 15 is smaller than breaking elongation of inner layer 20 is satisfied, since inner layer 20 is relatively easily elongated, the crack is unlikely to propagate to inner layer 20 due to the elongation of inner layer 20 even when the crack of tank body 10 propagates to primer layer 15. For example, when the relationship where breaking elongation of the material of primer layer 15 is larger than breaking elongation of the material of inner layer 20 is satisfied, since primer layer 15 is relatively easily elongated, the crack of tank body 10 is less likely to propagate to primer layer 15 due to the elongation of primer layer 15. As a result, the crack is less likely to propagate from primer layer 15 to inner layer 20. Further, it is expected that electrolyte 5 leaking from the crack can be retained in elongated primer layer 15. When the tensile strength of the material is different between primer layer 15 and inner layer 20, for example, if the relationship where the tensile strength of the material of primer layer 15 is smaller than the tensile strength of the material of inner layer 20 is satisfied, since primer layer 15 tends to be relatively easily elongated, the crack of tank body 10 is unlikely to propagate to primer layer 15 due to the elongation of primer layer 15. As a result, the crack is less likely to propagate from primer layer 15 to inner layer 20. Further, it is expected that electrolyte 5 leaking from the crack can be retained in elongated primer layer 15. For example, when the tensile strength of the material of primer layer 15 is larger than the tensile strength of the material of inner layer 20, since inner layer 20 tends to be relatively easily elongated, the crack is unlikely to propagate to inner layer 20 due to the elongation of inner layer 20 even when a crack of tank body 10 propagates to primer layer 15. The material of primer layer 15 can be appropriately selected so as to satisfy such a relationship of physical property values with the material of inner layer 20. That is, since the physical property value of the material of primer layer 15 differs from the physical property value of the material of inner layer 20, an interface between primer layer 15 and inner layer 20 exists between primer layer 15 and inner layer 20. Even when the crack occurs in tank body 10 the crack is less likely to propagate to inner layer 20 due to the presence of such an interface, as compared with the case where the physical property values are the same. A combination of materials of inner layer 20 and primer layer 15 that satisfies the relationship where the breaking elongation of the material of inner layer 20 is smaller than the breaking elongation of the material of primer layer 15 could be, for example, the material of inner layer 20 being the above-described resin and the material of primer layer 15 being rubber such as EPDM or FKM. Alternatively, the material of inner layer 20 is a composite of resin and fiber, and the material of primer layer 15 is only resin without fiber. Alternatively, the material of inner layer 20 is resin, and the material of primer layer 15 is resin having a breaking elongation larger than that of the resin constituting the inner layer. The combination of the material of inner layer 20 and the material of primer layer 15 that satisfies the relationship where breaking elongation of the material of inner layer 20 is larger than breaking elongation of the material of primer layer 15 is a combination opposite to the above-described combination.

A specific example of breaking elongation of each material is described below in the form of “material name: breaking elongation”. Polyethylene: 10 to 1200%, polyvinyl chloride: 40 to 450%, fiber reinforced resin: about 0.1 to 10% depending on the type of resin and fiber ratio, EPDM: 100 to 800%, fluorine rubber: 100 to 500%, epoxy: 3 to 6%, acrylic: 2 to 7%, polyester: 20 to 50%, polyacetal: 12 to 75%, fluorine resin: 80 to 400%, polyurethane: 100 to 10000%, unsaturated polyester: 1 to 6%, phenol: 0.4 to 2%, vinyl ester: 25 to 120%, polypropylene: 100 to 600%, nylon: 30 to 200%, ABS: 1.5 to 80%.

In general, the following magnitude relationship holds. For breaking elongation, the following applies: EPDM>(PET, PE, PVC)>FRP. For the tensile strength, the following applies: EPDM<(PET, PE, PVC)<FRP.

### <Thickness>

The thickness of primer layer 15 is, for example, 0.1 mm to 5 mm. The larger thickness of primer layer 15, the more primer layer 15 can fill the recesses on the inner side surface of tank body 10. As a result, inner surface 11 of tank body 10 is smoothed, and the flatness of inner surface 11 of tank body 10 is reduced. The thickness of primer layer 15 may be small as long as the function of primer layer 15 can be performed. When the thickness of primer layer 15 is 0.1 mm or more, inner surface 11 of tank body 10 is easily smoothed. When the thickness of inner layer 20 is 5 mm or less, the material and cost of primer layer 15 can be reduced. The thickness of primer layer 15 further may be 0.5 mm to 2 mm.

### <Forming Method>

Primer layer 15 can be formed by, for example, a coating method. The coating method is the same as that for inner layer 20, and thus detailed description thereof is omitted.

### Test Example 1

In order to evaluate the peeling strength of the inner layer with respect to the tank body, the following simulation test was performed.

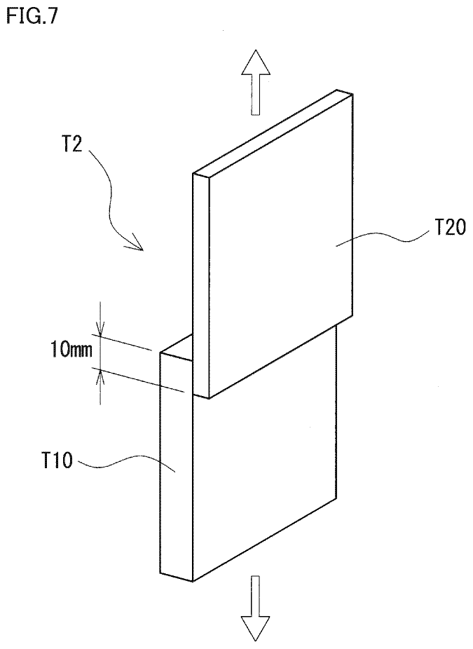

In this test, a test piece T2 shown in FIG. 7 is prepared. Test piece T2 includes a first member T10 simulating the tank body and a second member T20 simulating the inner layer. The areas of each of first member T10 and second member T20 are 100 mm square. First member T10 and second member T20 overlap each other within a range of 100 mm in width and 10 mm in length. The remaining portion of 100 mm in width and 90 mm in length of first member T10 does not overlap with second member T20.

Test piece T2 is produced as follows. First member T10 and an auxiliary substrate (not shown) are prepared. The auxiliary substrate has an area of 100 mm in width and 90 mm in length. The thickness of the auxiliary substrate is the same as that of first member T10. The 100 mm end surfaces of first member T10 and the auxiliary substrate are opposed to each other, and first member T10 and the auxiliary substrate are arranged so as to be adjacent to each other. A masking film is attached to a region of the surface of first member T10 except for a range of 100 mm in width and 10 mm in length from a side in contact with the auxiliary substrate. A masking film is attached to the entire surface of the auxiliary substrate. The masking film is formed of a material with excellent peeling properties. In a state in which first member T10 and the auxiliary substrate are arranged, the material of second member T20 is sequentially coated to the respective surfaces of first member T10 and the auxiliary substrate, and then the material is solidified. This operation is repeated until second member T20 has a predetermined thickness. After second member T20 is formed, the auxiliary substrate is removed. The second member formed in the region covered with the masking film of first member T10 is cut and removed together with the masking film. Through this method, test piece T2 can be produced.

In this test, test pieces of samples No. 1 to No. 7 and test pieces of samples No. 101 and No. 102 were prepared. The specifications of each sample are as shown in Table 1. In Table 1, “C” of the material of the first member indicates reinforced concrete, and “S” indicates carbon steel. The thickness of the reinforced concrete is 50 mm. The thickness of the carbon steels is 10 mm. The carbon steel is a rolled material. The flatness indicates flatness in the 100 mm square region in the surface of the first member. The material “FRP” of the second member is a mixture of PVC with short glass fibers.

The surface of first member T10 of the test pieces of samples No. 1 and No. 7 was mechanically polished. The surface of first member T10 of the test pieces other than samples No. 1 and No. 7 was not mechanically polished. The test pieces of samples No. 2 to No. 6 and No. 8 are provided with primer layer 15 shown in FIG. 6 on the surface of first member T10. Primer layer 15 is formed before the material of second member T20 is coated. Primer layer 15 is formed by coating a material of primer layer 15 to the surface of first member T10 and then solidifying the material. This operation is repeated until primer layer 15 has a predetermined thickness.

### (Measurement of Peeling Strength)

The peeling strength of the second member was measured for the test piece of each sample. The peeling strength is measured as follows. First member T10 and second member T20 are each held by a clamp, and a tensile test is performed. In the tensile test, first member T10 and second member T20 are pulled in a direction in which first member T10 and second member T20 are separated from each other along the surface of first member T10. The maximum tensile load until second member T20 peels off from first member T10 is measured. When second member T20 is not peeled off from first member T10 and is broken, it is considered unmeasurable. In this case, the peeling strength of second member T20 may be larger than the breaking strength. The value obtained by dividing the maximum tensile load by the area where first member T10 and second member T20 overlap is defined as the peeling strength of the second member. The test piece of each sample was evaluated for the peeling property of second member T20 from first member T10. The evaluation of the peeling property is “A” when second member T20 is peeled off from first member T10 without being broken, and is “B” when second member T20 is broken without being peeled off in the tensile test. The peeling strength of the second member and the evaluation of the peeling property of each sample are shown in Table 1.

When the material of the tank body and flatness, the material of the primer layer when the tank body has the primer layer, and the material of the inner layer are known, measurement of the peeling strength of the inner layer may be substituted with a simulated test using test piece T2 shown in FIG. 7 instead of the methods shown in FIG. 4 and FIG. 5.

### (Measurement of Breaking Strength)

Further, only second member having the 100 mm square was prepared, and the breaking strength of the second member was measured. The breaking strength of the second member was determined by performing a tensile test on the second member and measuring the maximum tensile stress until the second member was broken. The breaking strength of the second member in each sample is shown in Table 1.

TABLE 1

| | First Member | | | | | Second Member | | | | |
|---|---|---|---|---|---|---|---|---|---|---|
| | (Tank Body) | | Primer Layer | | | (Inner Layer) | | Peeling | Breaking | |
| Sample | | Flatness | Presence/ | | Thickness | | Thickness | Strength | Strength | |
| No. | Material | (mm) | Absence | Material | (mm) | Material | (mm) | (MPa) | (MPa) | Evaluation |
| 1 | C | 1 | Absent | — | — | FRP | 3 | 115 | 400 | A |
| 2 | C | 2 | Present | PET | 1 | FRP | 3 | 153 | 400 | A |
| 3 | C | 2 | Present | PET | 1 | PE | 3 | 10 | 30 | A |
| 4 | C | 2 | Present | PET | 1 | PVC | 3 | 23 | 60 | A |
| 5 | C | 2 | Present | PET | 1 | EPDM | 3 | 14 | 20 | A |
| 6 | C | 2.5 | Present | PET | 0.5 | FRP | 3 | 192 | 400 | A |
| 7 | S | 1 | Absent | — | — | FRP | 3 | 149 | 400 | A |
| 8 | S | 2 | Present | PET | 1 | FRP | 3 | 202 | 400 | A |
| 101 | C | 6 | Absent | — | — | FRP | 3 | Unmeasurable | 400 | B |
| 102 | S | 6 | Absent | — | — | FRP | 3 | Unmeasurable | 400 | B |

The evaluation of the peeling property was A in all of samples No. 1 to No. 8. The evaluation of the peeling property was B in samples No. 101 and 102. From the comparison between samples No. 1 and No. 101 and the comparison between samples No. 7 and No. 102, it is considered that the flatness of the inner surface of the tank body is preferably 5 mm or less.

Although the peeling strength of inner layer 20 with respect to tank body 10 has been described as being smaller than the breaking strength of inner layer 20, the difference between the peeling strength of inner layer 20 and the breaking strength of inner layer 20 may be described in detail. The difference varies depending on the material of inner layer 20. The difference in the case of PE may be 5 MPa or more, 10 MPa or more, or even 15 MPa or more. In the case of PVC, the difference may be 15 MPa or more, 20 MPa or more, or even 30 MPa or more. In the case of FRP, the difference may be 130 MPa or more, 150 MPa or more, or even 180 MPa or more. In the case of EPDM, the difference may be 3 MPa or more, or 5 MPa or more.

Further, from another viewpoint, the strength can be expressed by breaking strength/peeling strength, which is the ratio of breaking strength to peeling strength. The ratio of breaking strength to peeling strength is shown below based on Table 1.

In the case of PE, the ratio may be 2.0 or more, 2.5 or more, or even 2.8 or more. In the case of PVC, the ratio may be 1.8 or more, 2.0 or more, or even 2.5 or more. In the case of FRP, the ratio may be 1.5 or more, 1.8 or more, or even 2.0 or more. In the case of EPDM, the ratio may be 1.1 or more, or 1.3 or more.

In the samples No. 2 to No. 6 and No. 8 having primer layer 15, the material of primer layer 15 and the material of inner layer 20 are different. The physical property value of the material of primer layer 15 is also different from the physical property value of the material of inner layer 20. For example, in samples No. 2 and No. 6 in which the material of inner layer 20 is FRP, the breaking elongation of the material of primer layer 15 is different from that of inner layer 20. In this test, for samples No. 2 and No. 6, the breaking elongation of the material of primer layer 15 is larger than the breaking elongation of the material of inner layer 20. In these samples, even when a crack occurs in tank body 10, it is expected that the crack is unlikely to propagate to inner layer 20. In this test, for example, in sample No. 5 in which the material of inner layer 20 is EPDM, the breaking elongation of the material of inner layer 20 is larger than the breaking elongation of the material of primer layer 15. In the sample No. 5, the tensile strength of the material of primer layer 15 is larger than the tensile strength of the material of inner layer 20. In such a sample, even when a crack occurs in tank body 10, it is expected that the crack is unlikely to propagate to inner layer 20.

Regarding the measurement method of flatness, it is acceptable to measure it not only based on the aforementioned JIS B 0621:1984 “Definitions and Designations of Geometrical Deviations”, but also in the following manner. The flatness shown in Table 1 was measured as follows.
(1) The inner layer is removed from the inner surface of the tank body to expose the inner surface of the tank body.
(2) A separately prepared 100 mm square flat plate is brought into contact with the inner surface of the tank body.
(3) A gap that may be formed between the flat plate and the inner surface of the tank body is measured.
(4) The maximum value of the gap is defined as flatness.

The present disclosure includes the following embodiments.

### (Appendix 1)

A tank including:
a tank body; and
an inner layer disposed at an inner surface of the tank body,
in which the inner layer includes a lower layer provided at a surface of the tank body and an upper layer provided on the lower layer, and
in which a physical property value of a material of the lower layer and a physical property value of a material of the upper layer differ from each other.

### (Appendix 2)

A tank including:
a tank body; and
an inner layer disposed at an inner surface of the tank body,
in which the inner layer includes a lower layer provided at a surface of the tank body and an upper layer provided such that the lower layer is sandwiched between the tank body and the upper layer, and
in which a physical property value of a material of the lower layer and a physical property value of a material of the upper layer differ from each other.

### (Appendix 3)

The tank according to (Appendix 1) or (Appendix 2), in which breaking elongation of a material of the lower layer and breaking elongation of a material of the upper layer differ from each other.

### (Appendix 4)

The tank according to any one of (Appendix 1) to (Appendix 3), in which peeling strength of the upper layer with respect to the lower layer is smaller than breaking strength of the upper layer.

According to the configurations of the (Appendix 1) and (Appendix 2), since the lower layer and the upper layer have different physical property values, even when a crack occurs in the tank body, the crack is less likely to propagate to the upper layer due to the influence of the interface between the lower layer and the upper layer, as compared with the case where the physical property values are the same.

According to the configuration of the above (Appendix 3), since the states of breaking elongation of the respective layers are different, even when a crack occurs in the tank body, the crack is less likely to propagate to the upper layer.

According to the configuration of the above (Appendix 4), the peeling strength of the upper layer with respect to the lower layer is smaller than the breaking strength of the upper layer, and thus it is possible to suppress the occurrence of a crack in the upper layer even when the crack occurs in the tank body. The reason is that the upper layer is easily peeled off at the interface between the upper layer and the lower layer before the upper layer is broken by the crack occurred in the tank body. Thus, the tank of (Appendix 4) can suppress leakage of a substance such as an electrolyte in the tank to the outside of the tank. The peeling strength is an index indicating the adhesive force between the lower layer and the upper layer.

Regarding the materials of the upper layer and the lower layer, it is possible to correspond primer layer 15, as shown in the description of FIG. 6, to the lower layer and inner layer 20 to the upper layer. The material of primer layer 15 may be used for the lower layer, and the material of inner layer 20 may be used for the upper layer. To give a specific example, in a combination of the material of the lower layer and the material of the upper layer that satisfies the relationship where breaking elongation of the material of the lower layer is smaller than the breaking elongation of the material of the upper layer, for example, the material of the upper layer is resin, and the material of the lower layer is rubber such as EPDM or FKM. Alternatively, the material of the upper layer is a composite of resin and fiber, and the material of the lower layer is only resin without fiber. Alternatively, the material of the upper layer is resin, and the material of the lower layer is resin having a larger breaking elongation than the resin constituting the upper layer. Note that, as described in primer layer 15 and inner layer 20, when the relationship of breaking elongation has a reverse relationship, the combination of materials is also reversed.

Further, in Table 1, it is possible to correspond the primer layer to the lower layer and the inner layer to the upper layer. In samples No. 2 to No. 6 and No. 8 having the lower layer corresponding to the primer layer, the material of the lower layer and the material of the upper layer corresponding to the inner layer are different. In such a sample, even when a crack occurs in tank body 10, it is expected that the crack is unlikely to propagate to the upper layer.

### REFERENCE SIGNS LIST

1 redox flow battery system (RF battery system), 7 alternating current/direct current converter, 71 transformer facility, 8 power generation unit, 9 load, 2 tank, 2p positive electrolyte tank, 2n negative electrolyte tank, 10 tank body, 10a base, 11 inner surface, 15 primer layer, 20 inner layer, 21 adhesion portion, 3p, 3n pipe, 31 first pipe, 32 second pipe, 40 pump, 5 electrolyte, 6 jig, 100 battery cell, 101 membrane, 102 positive electrode cell, 103 negative electrode cell, 104 positive electrode, 105 negative electrode, 120 cell frame, 121 bipolar plate, 122 frame body, 127 seal member, 200 cell stack, 210 end plate, 230 fastening member, A region, T2 test piece, T10 first member, T20 second member.

1. A tank comprising:
a tank body; and
an inner layer disposed at an inner surface of the tank body, wherein peeling strength of the inner layer with respect to the tank body is smaller than breaking strength of the inner layer.

2. The tank according to claim 1, wherein the peeling strength is 500 MPa or less.

3. The tank according to claim 1, wherein a material of the inner layer is resin or rubber.

4. The tank according to claim 1, wherein a thickness of the inner layer is 0.5 mm to 20 mm.

5. The tank according to claim 1, wherein a material of the tank body is concrete or metal.

6. The tank according to claim 1, wherein a flatness of the inner surface of the tank body is 5 mm or less.

7. The tank according to claim 1, wherein the tank body includes a base and a primer layer provided at a surface of the base on an inner side, and wherein the primer layer constitutes the inner surface of the tank body.

8. The tank according to claim 7, wherein a physical property value of a material of the primer layer and a physical property value of a material of the inner layer differ from each other.

9. The tank according to claim 7, wherein breaking elongation of a material of the primer layer and breaking elongation of a material of the inner layer differ from each other.

10. A redox flow battery system comprising:
a positive electrolyte tank in which a positive electrolyte is stored and a negative electrolyte tank in which a negative electrolyte is stored, wherein at least one of the positive electrolyte tank and the negative electrolyte tank is the tank according to claim 1.
